(19) United States
(12) Patent Application Publication
(10) Pub. No.: US 2003/0036429 A1
(43) Pub. Date: Feb. 20, 2003

(54) Gaming machine with automated feature

(76) Inventors: Nigel Witty, Rosebery (AU); Natalie Bryant, Rosebery (AU); Nicholas L. Bennett, Rosebery (AU)

Correspondence Address: MORRISON & FOERSTER LLP, 755 PAGE MILL RD, PALO ALTO, CA, 94304-1018, US

(21) Appl. No.: 09/970,519

(22) Filed: Oct. 3, 2001

(30) Foreign Application Priority Data
Oct. 4, 2000 (AU) PR 0543

(51) Int. Cl. G06F 17/00

(52) U.S. Cl. 463/40

(57) ABSTRACT

The present invention provides a feature game facility operated purely at a system level in a linked system of EGMs. The feature game controller operates common features in such a way that each EGM is ‘unaware’ of the feature being played. EGMs 11 include a secondary display 12, in addition to the main EGM display 17 linked to a common site controller 13 via a communications network or link 14 and a common uni-directional communications protocol. The site controller 13 is responsible for operating and monitoring the feature games, and the display of the outcome is downloaded from the site controller 13 to the secondary displays 12 within the applicable EGMs II on the link 14.

An attendant can issue a command from the site controller 13 to commence a feature or tournament on either a single EGM, a subset of the EGMs or all of the EGMs 11 on the link 14. The display of the tournament progress will be on the secondary displays 12 within the EGMs 11 and have no effect on the normal play of the EGMs 11.

### INTRODUCTION

The present invention relates generally to gaming machines and in particular it provides an innovative bonus feature which operates over a number of gaining consoles over a network.

### BACKGROUND OF THE INVENTION

Currently, there exist automated and non-automated tournament features, progressive jackpots and so on that are played across multiple electronic gaming machines (EGMs). Some examples of existing systems are:

Hyperlink™ which involves a system of EGMs connected to a network (having a jackpot server (ie. linked) which collects a portion of the turnover from EGMs on the link as contributions to a pools which provide a number of levels of progressive jackpots. The EGM (or system) is used to determine a trigger condition that enters an EGM on the link into a feature. The outcome of the feature may or may not be the awarding of one of the levels of progressive jackpot, and may include the playing of a bonus game as a step towards the awarding of the jackpot.

A Mr. Cashman™ personality which involves a character which occasionally appears on the monitor of an EGM to perform certain functions such as paying bonus prizes, assisting the player, ordering drinks, entertaining the player and so on.

Automated tournament features such as progressive jackpot features like Hyperlink™ require that the software driving the display and outcome of the jackpot feature or tournament be run by the Electronic Gaming Machines (EGMs) on the link. This leads to extra software including graphics and sound being required as part of the EGM software hence consuming large amounts of valuable EGM memory. It also requires that separate software be developed especially for EGMs on the applicable links and hence those EGMs are not interchangeable with other EGMs within a venue. This also makes it difficult if not impossible to include multiple manufacturers' EGMs on a single link due to the negotiation required in order to implement identical feature outcomes on different hardware platforms using different programmers.

There also exists the concept of a ‘slot tournament’ that is used by clubs/casinos mainly for promotional reasons. This is a manually operated tournament and usually involves a set of EGMs being set aside for the tournament and having a certain amount of credits administered onto them by the attendants prior to commencement of the tournament. The players either pay a fixed fee to enter the tournament or are allowed to play free as a promotion, and are given a set time limit within which to win as much as they can. After the set time limit the player with the highest number of credits remaining is designated the winner, usually of a set prize or amount of money.

Slot tournaments do not necessarily require any special programming of the EGM. However the tournaments must be manually started and monitored by the venue operators. Attendants are required to set up and execute the tournament and hence staffing costs are increased. Also, turnover can not be occurring on the EGMs while they are being set up to begin the tournament and hence loss of potential income can be high. Disputes during the tournaments can also be difficult to settle due to the procedure being manual.

### SUMMARY OF THE INVENTION

According to a first aspect, the present invention consists in a gaming system comprising:

a plurality of EGMs, each of which is enabled to play a game by a player making a wager, and each having an EGM display means

a plurality of feature display means each of the feature display means being associated with a respective one of the plurality of EGMs and controlled independently of the respective EGM and its EGM display means

a controller which controls a feature game

the feature game being run on the controller and displayed on a selected one or more of the feature display means, the feature display means being eligible for selection if the respective associated EGM is being played at a rate greater than a minimum threshold rate

a contribution from each wager bet on each EGM is added to a prize pool

the feature controller awards a prize from the prize pool if the feature game displayed on the selected feature display achieves a prize winning result.

Preferably, embodiments of the current invention involve a linked system of EGMs operating common features purely at a system level, in such a way that each EGM is ‘unaware’ of the feature being played.

Each of the feature display means may be incorporated into a common housing with its respective associated EGM and EGM display means, however the feature displays may also be separately housed and/or located with at least a small distance separating the feature display and the respective EGM and EGM display. There may also be a mixture of both arrangements in a system such as when different manufacturers' equipment (with differing configurations) are combined in one installation.

In the preferred embodiment, each EGM would includes a secondary display in addition to the main EGM display, and the secondary display may be a LCD or monitor, or more simply a LED display or light globe(s).

The secondary displays are preferably all be linked to a common site controller via a communications network or link and a common communications protocol. The features are operated and monitored by the site controller, and the display of the outcome is downloaded from the site controller to the secondary displays. Alternatively, the software that drives the calculation and/or display of the feature may be housed within the EGM cabinet. Communications between the EGM and the site controller need only be unidirectional.

In the preferred embodiment, the site controller is provided with a user input to enable an attendant to issue a command which commences a tournament feature on either a subset of, or all of, the EGMs on the link. However other embodiments may involve a feature being run on only one EGM.

Preferably, when a tournament is commenced, all applicable EGMs will operate in the tournament mode for a certain period of time or until a certain event occurs which will be monitored by the site controller. The display of the tournament progress will be on the secondary displays within the EGMs and will have no effect on the normal play of the EGMs. Continued turnover on each EGM at a level greater than a predetermined minimum level will preferably be requisite to staying in the tournament. In an alternative implementation, the site controller may also automatically enter some or all of the EGMs on the network into the tournament mode upon the occurrence of a specific trigger.

Preferably also, the tournament will complete when a winner or winners have been determined. The winner might be, for example, the player who has generated the most turnover on their EGM or won the most credits on their EGM in a set time period. The winner may also be the winner of a competition, which may or may not include player input made directly to the secondary system, and may include games of pure chance or games which include an element of player skill. The skill required for skill based games may range from just above 0% to 100% (ie. almost pure chance to completely skill based). Player input when required may be via touch sensors on the second display or may be via a control panel associated with the secondary display. Examples of suitable competition games are a ‘tug-of-war’ match, boxing match, horse/vehicle race or treasure hunt between EGMs. The prize awarded can be for example, a non-cash prize or fixed cash amount determined by the venue, or a percentage of turnover on the EGMs generated during the feature or prior to the feature as for a progressive jackpot. The prize awarded can also be a bonus effect such as doubling the amount won on the EGM during the tournament and could apply to one, a subset of or all of the players involved in the tournament. Alternatively the prize may be the entire amount of a prize pool or subset of a pool that is a percentage of the increase in the pool since the last such prize was awarded (ie a progressive jackpot).

Embodiments of the invention can be extended for use with progressive features (such as Hyperlink™), such that when the feature system is triggered to award a feature game, which in turn determines a jackpot amount (or if a jackpot will be awarded at all) the feature is run on the secondary system. In other embodiments of the invention, less complicated features can also be implemented using simpler forms of display such as LEDs or light globes. In one such embodiment a ‘roaming light display’ is implemented in which lights continue to flash on EGMs around the link until one (or more) winning EGMs are the only ones remaining with lights on or flashing. The flashing of the lights/LEDs are driven by the site controller or logic box rather than the EGM software.

### BRIEF DESCRIPTION OF THE DRAWINGS

An embodiment of the invention will now be described in greater detail with reference to the accompanying drawings in which:

FIG. 1 is a block schematic diagram of a system arranged to implement an embodiment of the present invention;

FIG. 2 is a block diagram showing an EGM from the system of FIG. 1 in greater detail;

FIG. 3 is a perspective view of an EGM on which a secondary display is mounted in a top box of the EGM; and

FIG. 4 is a perspective view of an EGM on which a secondary display is mounted on the side of the EGM.

### DETAILED DESCRIPTION OF THE PREFERRED EMBODIMENT

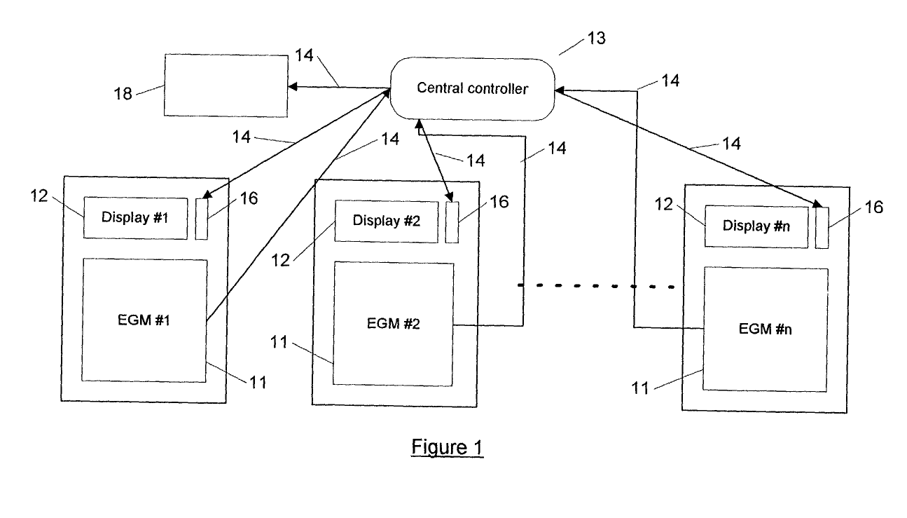

Referring to FIG. 1, embodiments of the current invention include features as mentioned above being operated purely at a system level. This would involve a linked system of EGMs operating common features in such a way that each EGM is ‘unaware’ of the feature being played.

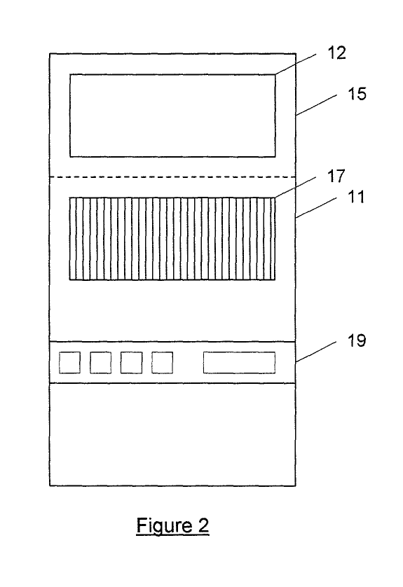

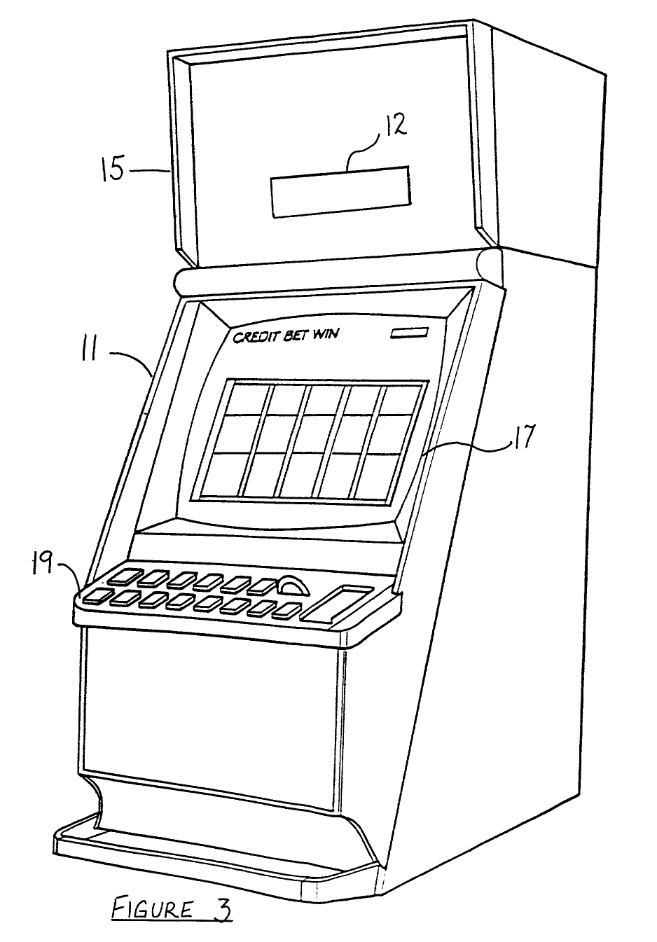

In the preferred embodiment, EGMs 11 would include a secondary display 12, in addition to the main EGM display 17 (refer to FIGS. 2, 3 & 4). The secondary display 12 may be a LCD or monitor, or more simply a LED display or light globe(s). These would all be linked to a common site controller 13 via a communications network or link 14 and a common communications protocol. The site controller 13 would be responsible for operating and monitoring the features. The display of the outcome would be downloaded from the site controller 13 to the secondary displays 12 within the applicable EGMs 11 on the link 14. Alternatively, the software that drives the calculation and/or display of the feature could be contained within a physically separate compartment 16 (referred hereinafter as ‘logic box’) within the confines of the EGM 11 (for example in the top box 15).

Communications between the EGM 11 and the site controller 13 and/or logic box would be via a common communications protocol and need only be unidirectional. This can be via a separate port from the EGM 11 designated specifically for this purpose, or could be ‘piggybacked’ off of a separate communications line being used for data collection from another system such as DACOM™ slot management system.

In the preferred embodiment, an attendant can issue a command from the site controller 13 to commence a feature or tournament on either a single EGM, a subset of the EGMs or all of the EGMs 11 on the link 14. In the case of multiple EGMs 11 all applicable EGMs 11 will then operate in a tournament mode for a certain time limit or until a certain event occurs which will be monitored by the site controller 13. The display of the tournament progress will be on the secondary displays 12 within the EGMs 11 (and possibly also on separate main displays 18) and will have no effect on the normal play of the EGMs 11. Continued turnover on each EGM 11 will preferably be requisite to staying in the tournament.

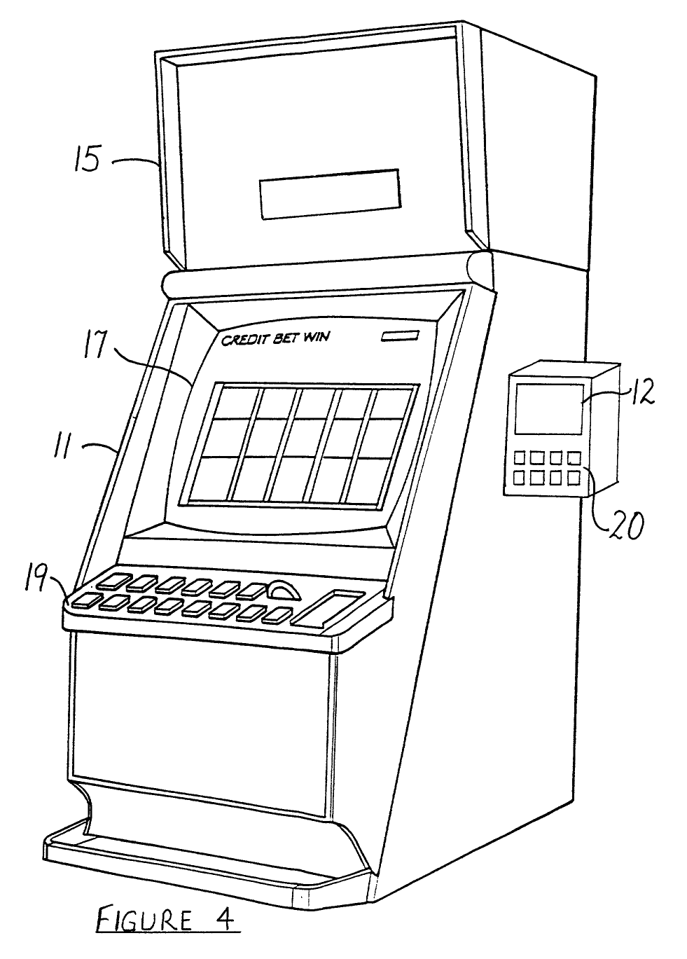

The tournament will complete when a winner or winners have been determined. This could be (but is not limited to) the player who has generated the most turnover on their EGM 11 or won the most credits on their EGM in a set time period. It could alternatively be the winner of a competition, which may or may not include player input directly to the secondary system and may include games of pure chance or games which include an element of player skill. The skill required for skill based games may range from just above 0% to 100% (ie. almost pure chance to completely skill based). Player input where required may be via touch sensors on the second display 12 or via a control panel 20 associated with the secondary display (refer FIG. 4) and which is independent of the player control panel 19 of the EGM. Some examples are a ‘tug-of-war’ match, boxing match, horse/vehicle race or treasure hunt between EGMs 11. The prize awarded can be for example, a non-cash prize or fixed cash amount determined by the venue, or a percentage of turnover on the EGMs generated during the feature or prior to the feature as for a progressive jackpot. The prize awarded can also be a bonus effect such as doubling the amount won on the EGM 11 during the tournament and could apply to one, a subset of, or all of the players involved in the tournament.

In an alternative implementation, the site controller 13 or logic box 16 is arranged to determine a trigger condition such that when the trigger condition is met, one EGM, a subset of the EGMs or all of the EGMs 11 on the link 14 are automatically entered into the tournament mode. The winner(s) of the tournament could be paid a prize comprising the entire amount of a prize pool or subset of a pool that is a percentage of the increase in the pool since the last such prize was awarded (ie a progressive jackpot).

In the case where the feature runs on a single EGM the “tournament” game will be the same that is provided when multiple EGMs enter the tournament mode, however if the game is one where the player must compete, the competition will be against the machine or against the clock. The game may also be one that does not require the player to compete in which case the game may be a conventional bonus game (eg a spinning reel game) and may either be an interactive or a non-interactive game.

Embodiments of the invention can be extended for use with progressive features such as Hyperlink™, such that when the hyperlink system is triggered to award a feature game, which in turn determines a jackpot amount (or if a jackpot will be awarded at all) the feature is run on the secondary system. In this way, the Hyperlink™ features can run at a level above the level of the EGM software, and hence can be applied to any manufacturer's EGMs as required. Hence a Hyperlink™ set up can be used for a link of multiple-manufacturers at a venue (similar to a Cashcade™ system), without requiring negotiations directly between the EGM manufacturers.

Also, the Mr. Cashman™ concept which involved the display of information, and entertainment and the awarding of prizes independently of the game played on the EGM, can be implemented on a system of secondary screens 12 either in conjunction with a tournament mode or progressive jackpot or separately. It can also be implemented on the secondary screen system for purposes such as advertising or implementing the above features in addition to being implemented as a part of the EGM software for other purposes.

Less complicated features can also be implemented using simpler forms of display such as LEDs or light globes. For example, a ‘roaming light display’ could be implemented where lights continue to flash on EGMs around the link until one (or more) EGMs are the only ones remaining with lights on or flashing to determine the winner(s). The flashing of the lights/LEDs would be driven by the site controller or logic box rather than the EGM software.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A gaming system comprising:
a) a plurality of EGMs, each of which is enabled to play a game by a player making a wager, and each having an EGM display means;
b) a plurality of feature display means each of the feature display means being associated with a respective one of the plurality of EGMs and controlled independently of the respective EGM and its EGM display means;
c) a feature controller which controls a feature game, the feature game being capable of being run on the controller and displayed on a selected one or more of the feature display means;
d) a prize pool to which a contribution is added from each wager bet on each EGM, wherein the feature controller awards a prize from the prize pool if the feature game displayed on the selected feature display achieves a prize winning result.

2. The gaming system of claim 1, wherein each of the feature display means becomes eligible for selection if the respective associated EGM is being played at a rate greater than a minimum threshold rate.

3. The system as claimed in claim 1, wherein the plurality of EGMs are linked in a communications network.

4. The system as claimed in claim 3, wherein a feature game is triggered when a trigger condition occurs, the feature game being a game which determines if a jackpot is to be awarded and a jackpot amount to be awarded, and the feature game is run on the feature controller and is displayed on the secondary display means of the respective EGM.

5. The system as claimed in claim 3, wherein the feature game displayed on the secondary display associated with each EGM is a common feature game operated at a system level on the feature controller, and whereby the information available to each EGM does not identify the feature game being played by the feature controller.

6. The system as claimed in claim 3, wherein each of the feature display means is separately housed and/or located with at least a small distance separating the feature display and the respective EGM and EGM display.

7. The system as claimed in claim 3, wherein each of the feature display means is incorporated into a common housing with its respective associated EGM and EGM display means.

8. The system as claimed in claim 7, wherein the feature display means comprises a secondary display means which is a Liquid Crystal Display (LCD).

9. The system as claimed in claim 7, wherein the feature display means comprises a secondary display means which is a CRT monitor.

10. The system as claimed in claim 7, wherein the feature display means comprises a secondary display means which is a Light Emitting Diode (LED) display.

11. The system as claimed in claim 7, wherein the feature display means comprises a secondary display means which is a lamp or a series of lamps.

12. The system as claimed in claim 11, wherein the feature game comprises a ‘roaming light display’ in which lamps continue to flash on EGMs around the link until one or more winning EGMs are the only ones remaining with lamps on or flashing.

13. The system as claimed in claim 12, wherein the feature controller comprises a comon site controller and the flashing lamps are driven by software running on the site controller.

14. A gaming system comprising:
a) a plurality of EGMs, each of which is enabled to play a game by a player making a wager, and each having an EGM display means;
b) a communications network which links the plurality of EGMs;
c) a plurality of feature display means each of the feature display means being associated with a respective one of the plurality of EGMs and controlled independently of the respective EGM and its EGM display means, the feature display means being linked to the communications network and comprising a secondary display means which is an image display;
d) a feature controller, comprising a common site controller linked to the communications network, the common site controller running a feature game, which is displayed on a selected one or more of the feature display means to which the site controller communicates via the communications network and a common communications protocol;
e) a prize pool to which a contribution is added from each wager bet on each EGM, wherein the feature controller awards a prize from the prize pool if the feature game displayed on the selected feature display achieves a prize winning result.

15 The gaming system of claim 14, wherein each of the feature display means becomes eligible for selection if the respective associated EGM is being played at a rate greater than a minimum threshold rate.

16. The system of claim 14, wherein the features are operated and monitored by the common site controller, and the display of the outcome is downloaded from the common site controller to the secondary displays.

17. The system of claim 14, wherein the software that drives the calculation and/or display of the feature game on each secondary display is run on a local feature display controller housed within a cabinet of the respective EGM and responsive to outcome data supplied by the common site controller.

18. The system as claimed in claim 17, wherein communications between a game controller of an EGM and the common site controller is unidirectional to communicate EGM data to the common site controller.

19. The system as claimed in claim 17, wherein communications between the common site controller and a local feature display controller is uni-directional to communicate feature game outcomes to the local feature display controller.

20. The system as claimed in claim 17, wherein the common site controller is provided with a user input to enable a person to issue a command, via the user input, to cause a tournament feature to commence on all of the EGMs on the link.

21. The system as claimed in claim 17, wherein the common site controller is provided with a user input to enable a person to issue a command via the user input to cause a tournament feature to commence on a subset of the EGMs on the link.

22. The system as claimed in claim 17, wherein the common site controller is provided with a user input to enable a person to issue a command via the user input to cause a tournament feature to commence on one of the EGMs on the link.

23. A gaming system comprising:
a) a plurality of EGMs, each of which is enabled to play a game by a player making a wager, and each having an EGM display means;
b) a communications network which links the plurality of EGMs;
c) a plurality of feature display means each of the feature display means being associated with a respective one of the plurality of EGMs and controlled independently of the respective EGM and its EGM display means, the feature display means being linked to the communications network and comprising a secondary display means which is an image display;
d) a feature controller, comprising a common site controller linked to the communications network, the common site controller running a feature game, which is displayed on a selected one or more of the feature display means to which the site controller communicates via the communications network and a common communications protocol whereby communication between the common site controller and a local feature display controller is unidirectional to communicate feature game outcomes to the local feature display controller;
e) a prize pool to which a contribution is added from each wager bet on each EGM, wherein the feature controller awards a prize from the prize pool if the feature game displayed on the selected feature display achieves a prize winning result; and
f) a user input associated with the common site controller to enable a person to issue a command via the user input to cause a tournament feature to commence on one or more of the EGMs on the link.

24. The gaming system of claim 23, wherein each of the feature display means become eligible for selection if the respective associated EGM is being played at a rate greater than a minimum threshold rate.

25. The system as claimed in claim 23, wherein when the tournament is commenced, all applicable EGMs will operate in the tournament mode for a predetermined period of time which is monitored by the common site controller.

26. The system as claimed in claim 23, wherein when the tournament is commenced, all applicable EGMs will operate in the tournament mode until a certain event occurs which is monitored by the common site controller.

27. The system as claimed in claim 26, wherein the display of the tournament progress is provided on the secondary displays associated with the EGMs and has no effect on the normal play of the EGMs.

28. The system as claimed in claim 27, wherein a requisite to a player staying in the tournament is the continued playing of the respective EGM by the player to maintain turnover on the respective EGM at a level greater than a predetermined minimum level.

29. The system as claimed in claim 28, wherein the common site controller automatically enter one or more of the EGMs on the network into the tournament mode upon the occurrence of a specific trigger.

30. The system as claimed in claim 29, wherein the tournament is completed when a winner or winners have been determined.

31. The system as claimed in claim 30, wherein the winner is the player who has generated the most turnover on their respective EGM.

32. The system as claimed in claim 30, wherein the winner is the player who has won the most credits on their respective EGM in a predetermined time period.

33. The system as claimed in any one of claims 30, wherein the winner is a player who is the winner of a competition associated with the tournament.

34. A gaming system comprising
a) a plurality of EGMs, each of which is enabled to play a game by a player making a wager, and each having an EGM display means;
b) a communications network which links the plurality of EGMs;
c) a plurality of feature display means each of the feature display means being associated with a respective one of the plurality of EGMs and controlled independently of the respective EGM and its EGM display means, the feature display means being linked to the communications network and comprising a secondary display means which is an image display;
d) a feature controller, comprising a common site controller linked to the communications network, the common site controller running a feature game, which is displayed on a selected one or more of the feature display means to which the site controller communicates via the communications network and a common communications protocol whereby communication between the common site controller and a local feature display controller provides communication of feature game outcomes to the local feature display controller;
e) a prize pool to which a contribution is added from each wager bet on each EGM, wherein the feature controller awards a prize from the prize pool if the feature game displayed on the selected feature display achieves a prize winning result; and
f) a user input associated with the common site controller to enable a person to issue a command via the user input to cause a tournament feature to commence on one or more of the EGMs on the link, the tournament being complete when a winner or winners have been determined and the winner of the tournament being a player who is the winner of a competition associated with the tournament.

35. The gaming system of claim 34, wherein each of the feature display means becomes eligible for selection if the respective associated EGM is being played at a rate greater than a minimum threshold rate.

36. The system as claimed in claim 34, wherein the competition includes player input made directly via controls associated with the secondary display.

37. The system of claim 36, wherein the player input when required is via touch sensors on the second display.

38. The system as claimed in claim 36, wherein the player input when required is via a control panel associated with the secondary display.

39. The system as claimed in claim 34, wherein the competition does not include player input made directly via controls associated with the secondary display.

40. The system as claimed in claim 34, wherein the competition includes games which include an element of player skill.

41. The system as claimed in claim 40, wherein the skill component of skill based games is just above a 0% skill component, such that the game is almost random.

42. The system as claimed in claim 40, wherein the skill component of skill based games is a 100% percent skill component, such that there is no randomness in the game.

43. The system as claimed in claim 34, wherein the competition includes games of pure chance.

44. The system as claimed in claim 34, wherein the competition game is a ‘tug-of war’ match between EGMs.

45. The system as claimed in claim 34, wherein the competition game is a boxing match between EGMs.

46. The system as claimed in claim 34, wherein the competition game is a horse race between EGMs.

47. The system as claimed in claim 34, wherein the competition game is a vehicle race between EGMs.

48. The system as claimed in claim 34, wherein the competition game is a treasure hunt conducted between EGMs.

49. The system as claimed in claim 34, wherein the prize awarded includes a non-cash prize.

50. The system as claimed in claim 34, wherein the prize awarded is a fixed cash amount determined by the venue.

51. The system as claimed in claim 34, wherein the prize awarded is a percentage of turnover on the EGMs generated during the feature game.

52. The system as claimed in claim 34, wherein the prize awarded is a percentage of turnover on the EGMs generated prior to the feature game.

53. The system as claimed in claim 34, wherein the prize is the entire amount of the prize pool.

54. The system as claimed in claim 34, wherein the prize is a subset of the prize pool that is a percentage of the increase in the pool since the last such prize was awarded.

55. The system as claimed in claim 34, wherein the prize awarded includes a bonus effect.

56. The system as claimed in claim 55, wherein the bonus effect is a doubling the amount won on the EGM during the tournament.

57. The system of claim 55, wherein the bonus effect is applied to one of the players involved in the tournament.

58. The system of claim 55, wherein the bonus effect is applied to a subset of the players involved in the tournament.

59. The system of claim 55, wherein the bonus effect is applied to all of the players involved in the tournament.

60. The system as claimed in claim 34, wherein the communication between the common site controller and a local feature display controller is unidirectional communication to provide communication of feature game outcomes to the local feature display controller.
